(19) United States
(12) Patent Application Publication
(10) Pub. No.: US 2006/0042097 A1
(43) Pub. Date: Mar. 2, 2006

(54) Fruits peeler

(76) Inventor: Steve Sanghoo Kim, Des Plaines, IL (US)

Correspondence Address: Steve S. Kim, APT 201, 1480 Jefferson ST, Des Plaines, IL, 60016, US

(21) Appl. No.: 10/927,856

(22) Filed: Aug. 27, 2004

(51) Int. Cl. A01D 1/00; B26B 13/00

(52) U.S. Cl. 30/279.6

(57) ABSTRACT

My new FRUITS PEELER WITH CUTTING PART is a very simple single piece of metal plate which have a round peeling part inside of metal and a cutter outside of the same metal to peel and cut fruits. I realized and invented that round peeling part is the most efficiency to peel out the round and convex surfaces of fruits. And I added a cutting part outside of the same metal to cut and eat comfortably. It is easy to make it because of one piece of single metal plate.

This is a very simple plate knife with a round peeling part inside of metal with a cutting part outside of the metal which having two functions.

### CROSS-REFERENCE TO RELATED APPLICATION

NOT APPLICABLE

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM

NOT APPLICABLE

### BACKGROUND OF THE INVENTION

To peel out skins of apple, honeydews or peaches so on are not easy. I invented a new simple, easier, faster and more safety FRUITS PEELER WITH CUTTING PART which have two functions to peel and cut. I thought that a round peeling part is the best fruits peeler for the round and convex fruits' surfaces to touch smoothly and widely. Adding a cutting part in the same knife may be much convenient to peel and cut to eat the fruits at same time.

### BRIEF SUMMARY OF THE INVENTION

Considering of round and convex surfaces of fruits and to give convenient peeling and cutting together, I invented a new FRUITS PEELER WITH CUTTING PART which having a round peeling part inside of metal and cutter outside of the same metal. This a simple single piece of knife will be most efficiency to peel and cut to eat with peeling smoothly, widely safety and fast at home or outside.

### BRIEF DESCRIPTION OF THE SEVERAL VIEWS OF THE DRAWING

FIG. 1: Total view of a new FRUITS PEELER WITH CUTTING PART: It shows that round peeling part is located inside of metal, and a cutting part is located outside of the same metal. This single piece of plate knife have two function.

FIG. 2: View of knife on the fruit: It shows that the peeling part placed smoothly, widely, and safetely on the round and convex fruit' surface.

FIG. 3: It shows that outside cutter cuts to slices to eat.

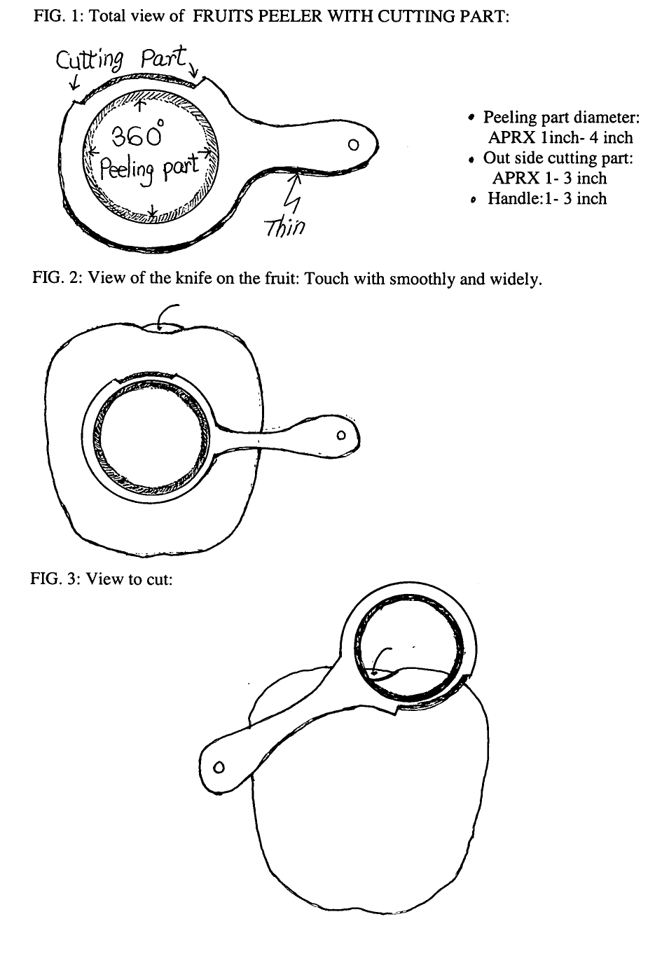

### DETAILED DESCRIPTION OF THE INVENTION

It is a very simple single plate of knife which have a round peeling part inside of metal and cutter outside of the same metal to use two functions to peel and cut of fruits. Because of the fruits' surfaces are round and convex, my round peeler will peel out smoothly, widely and faster to any direction. Just push, pull left or right. It is safety and convenient to peel and cut the fruits with one knife. It is easy to make it because of a single piece of plate.

I claim:

1. I claim to give me a patent number of my FRUITS PEELER WITH CUTTING PART which have a round peeling part inside of metal and cutting part outside of the same metal as a single piece of plate to peel and cut fruits.
